(19) United States
(12) Patent Application Publication
(10) Pub. No.: US 2005/0119976 A1
(43) Pub. Date: Jun. 2, 2005

(54) System and method for managing the performance of digital media in computer networks

(75) Inventors: Thomas M. Taylor, Kelowna (CA); Robert Arn, Kelowna (CA); Philip D. Stern, Toronto (CA)

Correspondence Address: Vermette & Co.;Granville Square, Suite 230, 200 Granville Street, Box 40, Vancouver, BC, V6C 1S4, CA

(73) Assignee: Crossflux Inc.

(21) Appl. No.: 10/986,903

(22) Filed: Nov. 15, 2004

Related U.S. Application Data
(60) Provisional application No. 60/519,647, filed on Nov. 14, 2003.

(51) Int. Cl. G06F 17/60

(52) U.S. Cl. 705/52

(57) ABSTRACT

A virtual broadcast system and method for managing the performance of digital media in computer networks is described which supports the exercise of the performance rights of creators and the accurate accounting and distribution of performance rights royalties.

### FIELD OF THE INVENTION

This invention pertains to enabling the performance of works of art or craft (such as recorded music, or live or recorded dramatic performance, or interactive computer entertainments) within computer networks. More specifically, it describes a system and method of exercising and protecting the performance rights belonging to the authors and/or publishers of such works when they are performed within computer networks.

### BACKGROUND OF THE INVENTION

The creators of works of art or craft have a number of common and statute law rights in relation to the exploitation of their works. They may control and license the enjoyment of those works by others and extensive commercial activity is based on the exercise of that legal control. The development of digital computer networks has introduced new modalities by which such works may be enjoyed and in the process has tended to disrupt established commercial interests and threaten the rights of creators and their ability to enjoy the benefits of such rights.

Chief among the disruptive effect of digital computer networks such as the Internet has been the rampant growth of “file sharing”, whereby a person with access to a digital copy of a work makes it available for unlicensed copying by anyone with connectivity to the Internet. Such persons have organized into distributed “peer-to-peer” networks that allow the rapid discovery and dissemination of works with no license revenue returning to the creators and rights-holders.

The practice is reaching the scale of a major attack on the principal of intellectual property. Extensive efforts to prevent such unlicensed copying and distribution through technical or legal action have failed to date. However, most efforts to create systems that are effective deterrents or alternatives to unlicensed copying, while very technically diverse, have explored very narrow territory. Specifically, they have focused on fighting unlicensed copying with copy protection or digital rights management systems. Such systems have tended to focus only on protecting one of several of the creator's rights—the right of reproduction or copying—without looking at the full range of creator's rights.

Creator's rights and their corresponding licensing rights and associated royalty benefits fall into a number of general categories. For example, rights for music creators fall into four general groups:
1. Copying rights and mechanical licenses and royalties—A mechanical license refers to permissions granted to mechanically reproduce music onto some type of media (e.g., cassette tape, CD, etc.) for public distribution. The music publisher grants permission for the musical composition to be reproduced. The purchaser of such a reproduction is typically free to unlimited personal enjoyment of the purchased reproduction. The mechanical royalty is paid to the recording artist, songwriter, and publisher based on the number of recordings sold.
2. Performance rights and royalties—A performance-rights license allows music to be performed live or broadcast.

These licenses may come in the form of a “blanket license,” which gives the licensee the right to play any work registered with a Performing Rights Organization (“PRO”) in exchange for a set fee. The performance royalty is paid to the songwriter and publisher by the PRO when a song is performed live or on the radio. The PRO is responsible for distributing funds based on its monitoring of the frequencies of actual performance.
3. Synchronization rights and royalties—A synchronization license is needed for a song to be reproduced onto a television program, film, video, commercial, radio, or even an 800 number phone message. It is called this because you are “synchronizing” the composition, as it is performed on the audio recording, to a film, TV commercial, or spoken voice-over. If a specific recorded version of a composition is used, you must also get permission from the record company in the form of a “master use” license. The synchronization royalty is paid to songwriters and publishers for use of a song used as background music for a movie, TV show, or commercial.
4. Print rights and royalties—This is a royalty paid to songwriters and publishers based on sales of printed sheet music.

In addition to these royalties, the Audio Home Recording Act of 1992 brought about yet another royalty payment for songwriters and performers. This act requires that the manufacturers of digital audio recording devices and the manufacturers of blank recording media (blank cassette tapes, blank CDs, blank DVDs, etc.) pay a percentage of their sales price to the Registrar of Copyrights to make up for loss of sales due to the possible unauthorized copying of music. There are two funds set up where this money is funneled. One is the Sound Recording Fund, which receives two-thirds of the money. This money goes to the recording artist and record company. The other fund is the Musical Works Fund, which receives the remaining one-third of the money to split 50/50 between the publisher and the songwriter.

While most people think of the creator's rights and benefits as flowing from copying rights and the associated mechanical licenses and royalties, the other categories of rights and licenses are substantial sources of revenue to creators and publishers. In particular, Performance Rights and Royalties provide an attractive balance of repeated revenue with low administrative cost because the creator does not license each performance directly to the end user, but indirectly through an intermediary who aggregates large numbers of performance royalties. The structure of the broadcast entertainment business is built on the foundation of Performance Rights and Royalties wherein the end user of the work does not make a direct license agreement for a mechanical copy with the creator or publisher, but enjoys the work as provided for performance through a broadcaster that has arranged a performance license with the creator or publisher through an intermediary which may be a Performing Rights Organization.

Rights of performance and associated royalties are not limited to a particular mode of performance. They span rights of live theatrical performance, film, radio and television.

New commercial categories are evolving that are based on the right of performance. For instance, the video rental industry which now represents a large proportion of the revenue flowing to film creators is based not on a mechanical copy license, but on a performance right associated with the rental.

Digital networks such as the Internet disseminate their signals via a packet-routing protocol that is different than the broadcast dissemination model of radio and television where performance rights and royalties are the norm. Nevertheless, a diverse set of “internet radio stations” has arisen that transmit digital audio streams on demand via the Internet. Such streams may be transmissions of traditional radio broadcasts or they may be programming specifically intended for Internet distribution. While not all of such “stations” are legally compliant with performance rights licensing by Performing Rights Organizations, those associated with licensed broadcast enterprises are properly licensed by PROs. As the bandwidth of typical user's Internet connections increases, one can anticipate that transmissions of “internet television stations” will also become commonplace.

The characteristics of such Internet broadcast stations show significant limitations that are imposed on the evolution of such new forms of broadcasting by the constraints of Internet transmission and, conversely, areas where the potential offered by the Internet is not realized within the systems that are currently in operation. Specifically, current Internet technologies make it bandwidth-inefficient to deliver digital media streams to a mass audience. This constrains the number of users and simultaneous streams that can be offered without incurring unacceptably high costs of network bandwidth and streaming server capacity. Scalability continues to be a problem because most existing Internet infrastructure is still based on routing data through a number of intermediate servers from a point of origin to a single destination. Streaming in this model is extremely inefficient, requiring essentially a separate stream for each user that is serviced which quickly overloads both the streaming server and the data link capacities. Multi-casting technologies are a response to such bottlenecks, but unfortunately current multi-casting protocols require that all the intervening servers between the origin server and the destination users be upgraded to support the multi-casting protocol. Hence multi-casting cannot be easily and transparently introduced into the existing heterogeneous Internet.

The goal of allowing maximal user selectivity of data is also at odds with multi-casting techniques. Ideally, each individual user would be free to specify the specific content and order of media that he or she would receive. However, this goal runs counter to the fundamental multi-casting approach which relies on sending the same data to multiple users at once.

Edge-caching is another measure to eliminate network and server bottlenecks that has been introduced by vendors such as Akamai to increase scalability by introducing multiple servers in different sectors of the Internet. Edge-caching does not degrade user selectivity, but unfortunately, the cost of edge-caching services can undermine the economics of media distribution systems that hope to capitalize on the Internet as a low-cost broadcast system.

The most extreme form of edge-caching is found in Peer to Peer Networks (“P2P”) which organize the computing facilities of individual end users to transmit data to other end users. P2P networks are also interesting in that they may go beyond edge-caching in allowing a client to transparently request data from a plurality of servers in parallel. However, P2P networks are ill-suited to broadcast streaming applications because they introduce unpredictable time delays in propagating a signal from an origination point to a variety of destinations. Today, P2P networks are primarily used in ad hoc copying of media files that contravenes or ignores the data owners' mechanical copyrights.

Equally, current internet broadcast models do not satisfy the desire of many Internet users to chose what works they want to experience and when they want to experience them without being bound by the choices and scheduling of broadcasters. All broadcast systems tend to limit selectivity both in content and time and deliver a single experience to a group at the same time. To overcome this problem requires both a bi-directional system in which users are capable of indicating their preferences, and the capability of responding to those preferences. Although this seems at first to be counter to the fundamentals of broadcast systems, we can see in the organization of actual broadcast systems attempts to provide increased user selectivity. For example, it is common among radio stations to accept user requests for specific music performances via telephone, or even through internet feedback. The limitation of traditional broadcasting is that, even if users are allowed to select the content, everyone is bound by the choice and must experience the same content at a given time. Internet broadcast systems have intrinsically more selectivity in two regards. First, the internet infrastructure is inherently bi-directional, so it is easy to gain feedback from the audience. Second, it is more easily possible to subdivide the channel capacity into multiple different streams to satisfy a variety of individual choices. Indeed, if bandwidth-saving techniques such as multi-casting are not used, it is clear that each user could have an individual stream of unique selections. However, as we have already noted, broadcast streaming techniques are inherently bandwidth limited and costs rise with growing audience size and introducing band-width saving measures reduces choice, an impasse.

The current invention describes a system and method for overcoming the bandwidth-inefficiencies of current Internet broadcast systems as well as providing a much greater degree of choice of works and timing of performance to the user while assuring the flow of performing rights royalties to the creator or publisher of the works.

### SUMMARY OF THE INVENTION

A virtual broadcast system and method for managing the performance of digital media in computer networks is described which supports the exercise of the performance rights of creators and the accurate accounting and distribution of performance rights royalties.

In one embodiment of the invention, which shall be called the Client/Server embodiment for identification purposes, one or more Performance Rights Database Servers and one or more Media Servers are connected to a network such as the Internet in such a manner that a plurality of Receiving Clients which are also connected to the network may communicate with them. Receiving Clients may be personal computers or other apparatus that include facilities to present or process and store digital media such as audio or music, video or movies, interactive computer games, or other media and which provide a keyboard, pointing device, remote control, gamepad, joystick or other user-interactive device whereby a user may indicate selections and initiate actions of the Receiving Client. Through the Receiving Client, a user selects a specific instance of media, or a list of media instances, or a category or categories of media and communicates that request to a Media Server through a network protocol such as Hypertext Transfer Protocol. The Media Server transmits a Buffer Stream to the Receiving Client which stores the Buffer Stream in a memory or storage system. The Buffer Stream is encoded in a manner that makes it impossible for the Receiving Client or other computing device to generate a performance of the media without the addition of further data which may be the addition of missing data in the Buffer Stream or the addition of a key which will authorize the decryption of the Buffer Stream and its presentation through special software which is installed on the Receiving Client. Immediately, or at a later time, the user may request performance of all or any of the media that has been transmitted in said Buffer Stream. At such point, software on the Receiving Client communicates with the Media Server, requesting a performance of the designated media. If the requestor is authorized to perform the selected media, the Media Server sends the Receiving Client an authorization message that includes the missing data or key that enables the Buffer Stream to be played through the software on the Receiving Client. At the same time, the Media Server sends a message to the Performance Rights Server which includes data which identifies the media performed. Periodically, the data accumulated on the Performance Rights Server is transmitted to a Performing Rights Organization or other body responsible for the distribution of performance royalties, where the data are used to calculate the division of royalties the organization has collected or will collect from the entity which is providing the media performances to the end user through the Media Server.

In another embodiment of the invention, which shall be called the Coordinated Peer-to-Peer embodiment for identification purposes, one or more Performance Rights Database Servers and one or more Coordinating Media Servers are connected to a network such as the Internet in such a manner that a plurality of Receiving Clients including Client Media Servers which are also connected to the network may communicate with them. Receiving Clients may be personal computers or other apparatus that include facilities to present or process and store digital media such as audio or music, video or movies, interactive computer games, or other media and which provide a keyboard, pointing device, remote control, gamepad, joystick or other user-interactive device whereby a user may indicate selections and initiate actions of the Receiving Client and whereby the Client Media Server may respond to requests for data from other Receiving Clients and transmit said data to them. Through the Receiving Client, a user selects a specific instance of media, or a list of media instances, or a category or categories of media and communicates that request to a Media Server through a network protocol such as Hypertext Transfer Protocol. The Coordinating Media Server either transmits a Buffer Stream to the Receiving Client which stores the Buffer Stream in a memory or storage system, or it relays the request to another Coordinating Media Server or to one or more other Client Media Servers so that the requested Buffer Stream is returned to the requesting Receiving Client. The Buffer Stream is encoded in a manner that makes it impossible for the Receiving Client or other computing device to generate a performance of the media without the addition of further data which may be the addition of missing data in the Buffer Stream or the addition of a key which will authorize the decryption of the Buffer Stream and its presentation through special software which is installed on the Receiving Client. Immediately, or at a later time, the user may request performance of all or any of the media that has been transmitted in said Buffer Stream. At such point, software on the Receiving Client, communicates with the Coordinating Media Server, requesting a performance of the designated media. If the requester is authorized to perform the selected media, the Coordinating Media Server sends the Receiving Client an authorization message that includes the missing data or key that enables the Buffer Stream to be played through the software on the Receiving Client. At the same time, the Coordinating Media Server sends a message to the Performance Rights Server which includes data which identifies the media performed. Periodically, the data accumulated on the Performance Rights Server is transmitted to a Performing Rights Organization or other body responsible for the distribution of performance royalties, where the data are used to calculate the division of royalties the organization has collected or will collect from the entity which is providing the media performances to the end user.

In another embodiment of the invention, which shall be called the Independent Peer-to-Peer embodiment for identification purposes, one or more Performance Rights Database Servers and one or more Media Servers are connected to a network such as the Internet in such a manner that a plurality of Receiving Clients including Client Media Servers which are also connected to the network may communicate with them. Receiving Clients may be personal computers or other apparatus that include facilities to present or process and store digital media such as audio or music, video or movies, interactive computer games, or other media and which provide a keyboard, pointing device, remote control, gamepad, joystick or other user-interactive device whereby a user may indicate selections and initiate actions of the Receiving Client and whereby the Client Media Server may respond to requests for data from other Receiving Clients and transmit said data to them. Through the Receiving Client, a user selects a specific instance of media, or a list of media instances, or a category or categories of media and communicates that request to the local Media Server of the Receiving Client which maintains a local table of other Media Servers that can satisfy the request or alternatively provides query capabilities such that it can communicate a query or request to a plurality of Media Servers on the network which are associated with other Receiving Clients. When such other Media Server or Servers is identified, a request is initiated to said Server and the Media Server or Servers transmit a Buffer Stream to the Receiving Client which stores the Buffer Stream in a memory or storage system. The Buffer Stream is encoded in a manner that makes it impossible for the Receiving Client or other computing device to generate a performance of the media without the addition of further data which may be the addition of missing data in the Buffer Stream or the addition of a key which will authorize the decryption of the Buffer Stream and its presentation through special software which is installed on the Receiving Client. Immediately, or at a later time, the user may request performance of all or any of the media that has been transmitted in said Buffer Stream. At such point, software on the Receiving Client, communicates with the Performance Rights Server, requesting a performance of the designated media. If the requester is authorized to perform the selected media, the Performance Rights Server sends the Receiving Client an authorization message that includes the missing data or key that enables the Buffer Stream to be played through the software on the Receiving Client. At the same time, the Performance Rights Server creates a record which includes data which identifies the media performed and a unique identifier for the Receiving Client through which the performance was effected. Periodically, the data accumulated on the Performance Rights Server is transmitted to a Performing Rights Organization or other body responsible for the distribution of performance royalties, where the data are used to calculate the division of royalties the organization has collected or will collect from the entity which is providing the media performances to the end user through the Media Server.

In each of the described exemplary embodiments of the invention, a number of exemplary methods of payment are described. As described above, the Performing Rights Organization or other body (which will be called PRO for ease of reference) aggregates the records of performances and uses the data to calculate the division of royalties that the organization has collected or will collect from the entity which is providing the media performances to the end user. For ease of reference we will call such entity the Broadcaster. There are then a number of parties to the payment chain—the end user, the Broadcaster, the PRO and the Publisher and/or Creator. In this invention, the traditional relationship between Broadcaster, PRO and Publisher/Creator is maintained. The Publisher/Creator registers a work with the PRO, thereby appointing the PRO as its licensing agent. The Broadcaster contracts with the PRO for a performance license including terms of royalty payments, which may be for specific works or a blanket license to all the works registered with the PRO. The descriptions above show how the invention enables and tracks performances, returning data to the PRO which will allow the PRO to disburse royalties to specific Publishers/Creators on the basis of which works were actually performed.

### BRIEF DESCRIPTION OF THE FIGURES

FIG. 1 is a block diagram of a system with a client/server architecture for managing the performance of digital media in networks which is used in practicing an embodiment of the invention.

FIG. 2 is a block diagram of a system with a coordinated peer-to-peer (“P2P”) architecture for managing the performance of digital media in networks which is used in practicing an embodiment of the invention.

FIG. 3 is a block diagram of a system for managing the performance of digital media in networks which is financed by advertising inserted in the digital media which is used in practicing an embodiment of the invention.

FIG. 4 is a block diagram of a system for managing the performance of digital media in networks which is financed by performance fees paid by end users which is used in practicing an embodiment of the invention.

FIG. 5 is a block diagram of a system for managing the performance of digital media in networks which is financed membership fees from users and/or and contributions from other parties which is used in practicing an embodiment of the invention.

FIG. 6 is a block diagram of enhanced data-mining functions which may be deployed to create preferred embodiments of the systems for managing the performance of digital media in networks described in relation to FIGS. 1 to 6 in accordance with the present invention.

### DETAILED DESCRIPTION OF THE PREFERRED EMBODIMENTS

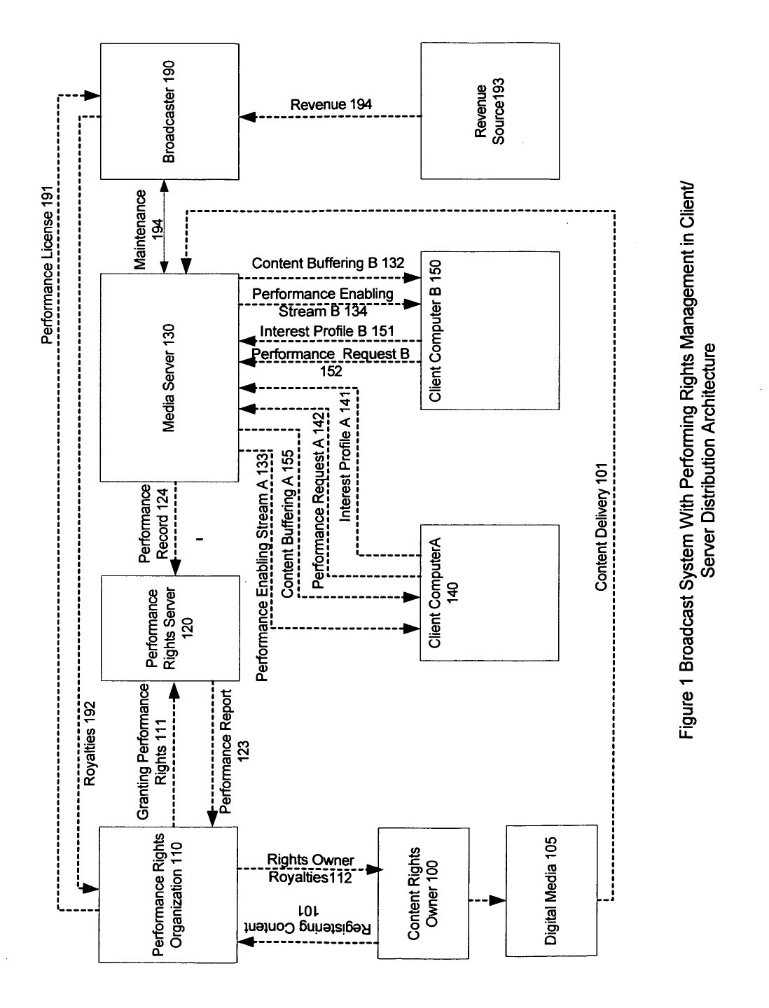

FIG. 1 shows a block diagram of a system for managing the performance of digital media in networks in accordance with the present invention. The system with a client/server architecture includes one or more Performance Rights Servers 120, one or more Media Servers 130 and a plurality of Client Computers 140 and 150 all communicating on a network, and as well certain individuals and organizations that play essential roles in the operation of the system, specifically, a Performance Rights Organization 110, a Content Rights Owner 100, a Broadcaster 190, and a Revenue Source 193. In FIG. 1, one or more Content Owners 100 contract with a Performance Rights Organization 110 to act on their behalf in licensing performances of a work of art or craft Digital Media 105 by registering the work, Registering Content 101 with the Performance Rights Organization 110. Acting as agent for said Content Rights Owner 100, said Performance Rights Organization contracts a Performance License 191 with a Broadcaster 190 whereby the broadcaster may deliver performances of said Digital Media in return for Royalties 192 which are paid to the Performing Rights Organization 110 as agent for the Content Rights Owner 100. The Digital Media 105 is loaded (Content Delivery 101) on a Media Server 130 which is operated and maintained by or on behalf of Broadcaster 190 to provide performances of Digital Media to audiences on Client Computers via a network. To experience performances, an end-user audience member using Client Computer A 140 first indicates an interest in a genre or type of digital media, or designates a list of available digital media, or an individual instance of a digital media, by sending Interest Profile A 141 to the Media Server 130. The Media Server sends a stream consisting of a part of Digital Media 105 to Client Computer A 140 as a background process Content Buffering a 155 which does not interrupt any other activities that the user may be undertaking on Client Computer A 140, however, the stream as delivered to said client computer cannot be performed by virtue of missing or encrypted parts. To experience a performance of said digital media, the end-user through Client Computer A 140 sends a Performance Request A 142 to Media Server 130. If the user is authorized to receive a performance of the requested Digital Media, said Media Server will send Performance Enabling Stream A 133 to Client Computer A 140 and a Performance Record 124 to the Performance Rights Server 120 where such records are accumulated in persistent form. The Performance Enabling Stream A 133 when combined with the Content Buffering A 155 previously delivered, will enable a performance of the Digital Media 105. Successive requests to experience a performance of the same digital media will repeat the cycle of sending a Performance Enabling Stream from the Media Server to the Client Computer and a Performance Record to the Performance Rights Server so that the Performance Rights Server accumulates a record of each performance of the digital media.

The specific criteria which determine authorization and the interactions between the end-user and the Media Server which trigger the Media Server to authorize a particular performance will be dependent on the specific commercial model of the overall broadcast system, but will involve some sort of transfer of Revenue 194 from a Revenue Source 193 to the Broadcaster 190. The Broadcaster pays Royalties 192 to the Performance Rights Organization 110. These Royalties may not be directly co-related to individual performances of specific Digital Media since it is common for performance rights licenses between Performance Rights Organizations and Broadcasters to be blanket licenses that authorize the broadcaster to deliver performances of all or a large portion of all the works registered with the Performing Rights Organization for a flat license fee. This introduces the need to deliver feedback to the Performance Rights Organization as to which works were actually performed and with what frequency, so that the PRO may fairly apportion the Royalties 192 to the Content Rights Owner 100. To allow the PRO to calculate the proper apportionment of royalties to specific content rights owners, the Performance Rights Server 120 summarizes the specific performance frequency information derived from Performance Record 124 messages and forwards a Performance Report 123 to the PRO.

A practitioner skilled in the art will recognize that the description of the system is intended to be broadly illustrative rather than prescriptive and one skilled in the art will understand that a variety of physical and logical architectural variations are possible without changing the fundamental function of the invention. As well, such a practitioner will understand that the description of individual components of the system has been simplified to eliminate sub-systems and components that could be easily inferred by a skilled practitioner. For example, Client Computer A 140 and Client Computer B 150 may be assumed to be any of a wide variety of end-user computers that are capable of attaching to a network, including desktop PCs, laptop PCs, PDAs, or cellphones and specialty media appliances, limited only by the capability of providing user interaction to generate the described functions of the system and to present a performance of the requested digital media. Equally, the Performing Rights Server 120 and Media Server 130 will be recognized as potentially existing in a wide variety of forms, including, for example personal computers, mini-computers and even mainframe computers, limited only by the capability of attaching to a network, and executing the described functions of the Media Server. As well, although the Internet represents the dominant network today utilized for commercial data distribution, the invention is indifferent to the specifics of network type and might equally be implemented, for example on a local area network, a proprietary wide-area network, or any of a variety of wireless networks.

The skilled practitioner will understand that the description provided for this embodiment of the invention represents a distributed network application in a client/server arrangement and that specific functions might be located in different positions in the network, solely for convenience or performance reasons, without affecting the basic functioning of the invention. For example, the Performance Rights Server 120 and the Media Server 130 could easily be combined in many applications of the invention into a single server, producing greater simplicity and higher performance. However, they have been represented separately because in some implementations the Performing Rights Organization 110 may wish to control the Performance Rights Server 120 so as to ensure that an audit of performance frequencies is possible separate from the Broadcaster who usually will control the Media Server 130. It is equally possible for a skilled practitioner to anticipate that there might be multiple instances of either Performance Rights Servers associated with multiple Performing Rights Organizations and multiple Media Servers associated with each Performing Rights Server or with multiple Performing Rights Servers and that the functions of a single Media Server here represented might be divided onto multiple specialized Media Servers for performance or flexibility.

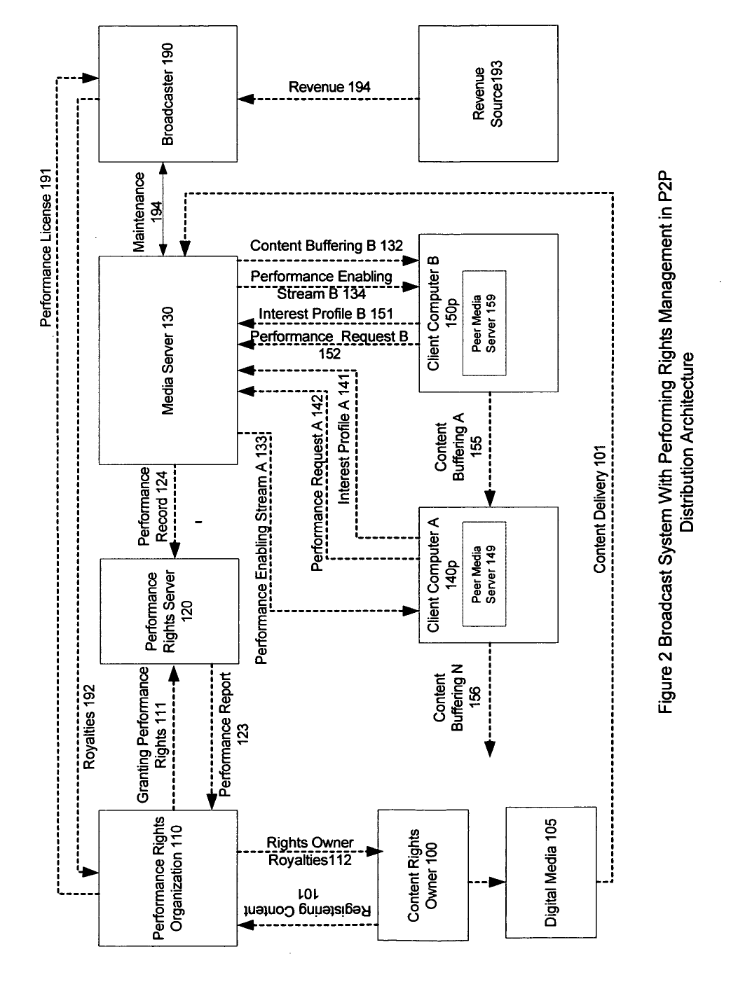

FIG. 2 shows a block diagram of another embodiment of a system for managing the performance of digital media in networks in accordance with the present invention. The system with a coordinated peer-to-peer (“P2P”) architecture includes one or more Performance Rights Servers 120, one or more Media Servers 130 and a plurality of Client Computers 140p and 150p all communicating on a network, and as well certain individuals and organizations that play essential roles in the operation of the system, specifically, a Performance Rights Organization 110, a Content Rights Owner 100, a Broadcaster 190, and a Revenue Source 193. In FIG. 2, one or more Content Owners 100 contract with a Performance Rights Organization 110 to act on their behalf in licensing performances of a work of art or craft Digital Media 105 by registering the work, Registering Content 101 with the Performance Rights Organization 110. Acting as agent for said Content Rights Owner 100, said Performance Rights Organization contracts a Performance License 191 with a Broadcaster 190 whereby the broadcaster may deliver performances of said Digital Media in return for Royalties 192 which are paid to the Performing Rights Organization 110 as agent for the Content Rights Owner 100. The Digital Media 105 is loaded (Content Delivery 101) on a Media Server 130 which is operated and maintained by or on behalf of Broadcaster 190 to provide performances of Digital Media to audiences on Client Computers via a network.

To experience performances, a first end-user audience member using Client Computer B 150 indicates an interest in a genre or type of digital media, or designates a list of available digital media, or an individual instance of a digital media, by sending Interest Profile A 151 to the Media Server 130. The Media Server sends a stream consisting of a part of Digital Media 105 to Client Computer B 150 as a background process Content Buffering B 132 which does not interrupt any other activities that the user may be undertaking on Client Computer A 150, however, the stream as delivered to said client computer cannot be performed by virtue of missing or encrypted parts. To experience a performance of said digital media, the end-user through Client Computer B 150 sends a Performance Request A 152 to Media Server 130. If the user is authorized to receive a performance of the requested Digital Media, said Media Server will send Performance Enabling Stream B 134 to Client Computer A 150 and a Performance Record 124 to the Performance Rights Server 120 where such records are accumulated in persistent form. The Performance Enabling Stream B 134 when combined with the Content Buffering B 132 previously delivered, will enable a performance of the Digital Media 105. Successive requests from the same Client Computer to experience a performance of the same digital media will repeat the cycle of sending a Performance Enabling Stream from the Media Server to the Client Computer and a Performance Record to the Performance Rights Server so that the Performance Rights Server accumulates a record of each performance of the digital media.

However, a request for performance of Digital Media 105 from another Client Computer A 140p will follow a slightly different path in order to reduce the load of downloading Content Buffering streams on the Media Server. When Client Computer A 140p submits Interest Profile A 141 to Media Server 130 with a request that triggers download of Content Buffering A 155, Media Server 130 does not necessarily download the Content Buffering itself, but may re-direct the request to one or more peer Client Computers, in this case to Client Computer B 150 where the download is performed by Peer Media Server 141. When the end-user of Client Computer A 140 requests a performance, Performance Request A 142, however, the request is serviced by Media Server 130 returning Performance Enabling Stream A 133, not re-directed to Peer Media Server 141. This is because the goal of the P2P architecture in this embodiment of the invention is to reduce the download burden on the Media Server 130 without compromising the control and security of the digital media distribution. Maintaining the authorization and enabling function on the Media Server 130 provides a single point of security control through which it is simpler to provide robust security. Said Performance Enabling Stream A in combination with the Content Buffering A delivered from the Peer Media Server 141 allows the performance of the requested Digital Media 105.

The specific criteria which determine authorization and the interactions between the end-user and the Media Server which trigger the Media Server to authorize a particular performance will be dependent on the specific commercial model of the overall broadcast system, but will involve some sort of transfer of Revenue 194 from a Revenue Source 193 to the Broadcaster 190. The Broadcaster pays Royalties 192 to the Performance Rights Organization 110. These Royalties may not be directly co-related to individual performances of specific Digital Media since it is common for performance rights licenses between Performance Rights Organizations and Broadcasters to be blanket licenses that authorize the broadcaster to deliver performances of all or a large portion of all the works registered with the Performing Rights Organization for a flat license fee. This introduces the need to deliver feedback to the Performance Rights Organization as to which works were actually performed and with what frequency, so that the PRO may fairly apportion the Royalties 192 to the Content Rights Owner 100. To allow the PRO to calculate the proper apportionment of royalties to specific content rights owners, the Performance Rights Server 120 summarizes the specific performance frequency information derived from Performance Record 124 messages and forwards a Performance Report 123 to the PRO.

A practitioner skilled in the art will recognize that the description of the system is an example of a Peer-to-Peer distribution architecture and that there are many variants of P2P implementations which would equally serve the same function in the invention as the particular variant here represented and that the system is subject to the same variability in its component parts as the Client/Server system described in FIG. 1. Equally, the skilled practitioner will understand that there are many variants of the specific interactions described and the described interactions are not intended to be fixed and prescriptive. For instance, it is not necessarily the case that Media Server 130 would only download a particular Content Buffering to a single Client Computer and then let the requests be serviced just by Client Computers, but the Media Server might participate in all downloads until it reached a threshold of capacity or other scheme of managing its capacity. Finally, it will be obvious to the skilled practitioner that the P2P architecture is scalable to large numbers of Client Computers as suggested by the inclusion of a Content Buffering N 156 from Peer Media Server 149 on Client Computer A 140 and that the efficiency of the P2P architecture in off-loading download tasks from the Media Server 130 will increase as the number of Client Computers increases.

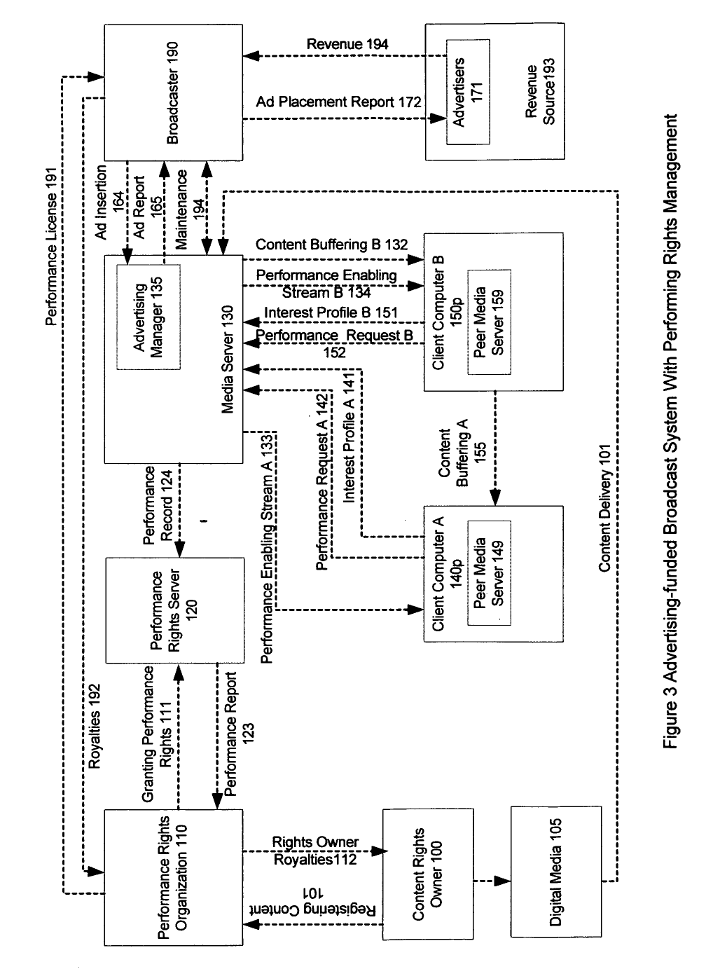

FIG. 3 shows a block diagram of another embodiment of a system for managing the performance of digital media in networks in accordance with the present invention. In this embodiment, the system is adapted to function as an advertising-financed broadcast system. In FIG. 3 the overall system is based on the P2P architecture described in FIG. 2. However, the embodiment described in FIG. 3 could function equivalently in under the client/server architecture described in FIG. 1. In FIG. 3, the process of granting licenses for performance of Digital Media 105 from a Content Rights Owner 100 to a Performance Rights Organization 110 as an agent which then grants a Performance License 191 to a Broadcaster 190 who broadcasts performances of Digital Media 105 to end-users through a network to a plurality of Client Computers 140p and 150p is identical to that described in FIG. 2 and FIG. 1. Equally, the detailed interactive process by which the performance is authorized and distributed to the client computers and the process by which the performance records are delivered to the Performance Rights Organization 110 for disbursement to Content Rights Owner 100 is identical to the process of FIG. 2 and the present embodiment would function equivalently in the slightly different interactions described relative to FIG. 1.

The substantive difference presented in the embodiment represented in FIG. 3 relates to the functions which control the revenue-generating activity, which in this embodiment involves the insertion of advertising content into performances of digital media or between successive performances of digital media. In FIG. 3, the Revenue Source 193 is Advertisers 171 who pay Revenue 194 to Broadcaster 190 in return for the Broadcaster 190 inserting advertising media (Ad Insertion 164) into the Digital Media 105 that is disseminated by Media Server 130 to client computers. Media Server 130 is enhanced with an Advertising Manager 135 function that receives advertising content and instructions as to the mode and frequency of insertions from Broadcaster 190 through As Insertion 164 interactions. Said Ad Insertion 164 interactions may be performed either through personnel of Broadcaster 190 interacting with Media Server 130 directly, or by means of remote messages, data transfers and instructions through a network. The Ad Insertion 164 data and instructions may result in advertising material being inserted within digital media or between different performances of digital media, depending on the length and type of digital media and the insertion may occur into either Content Buffering B132 or A155 or into Performance Enabling Stream A 133 or B 134. Each time an advertisement is inserted and a performance is enabled through a Performance Enabling Stream, the Advertising Manager 135 of the Media Server 130 accumulates a persistent record of the advertising placement. Said Advertising Manager sends Ad Report 165 to Broadcaster 190 which is either a message for each advertisement placement or a periodic accumulation of the advertising data to Broadcaster 190. Said Broadcaster periodically extracts an Ad Placement Report 172 from the data of Ad Report 165 and delivers said Ad Placement Report to Advertisers 171 in substantiation of performance of the contracted advertising services for which said Advertisers pay Revenue 194 to Broadcaster 190.

A practitioner skilled in the art will recognize that the system description above is simplified for greater clarity and represents a distributed processing application where functions are distributed at multiple points within a network and that specific functions may be moved from one processing node in the network to another without altering the invention. As a specific example, the functions of extracting an Ad Placement Report from the persistent records of advertisement exposures which is described within Broadcaster 190 might be moved to Media Server 130 with no change in functionality and Advertisers 171 might communicate directly with Media Server 130 to receive Ad Placement Report 172 instead of through Broadcaster 190. The skilled practitioner will also realize that different implementations of the same described functions will result in different message directions or proliferation of messages where one is described above. As a specific example, where Ad Report 164 is described as a message initiated from Media Server 130 to Broadcaster 190, depending on routine implementation details, Ad Report 164 might equally be a response to a query from Broadcaster 190 to Media Server 130.

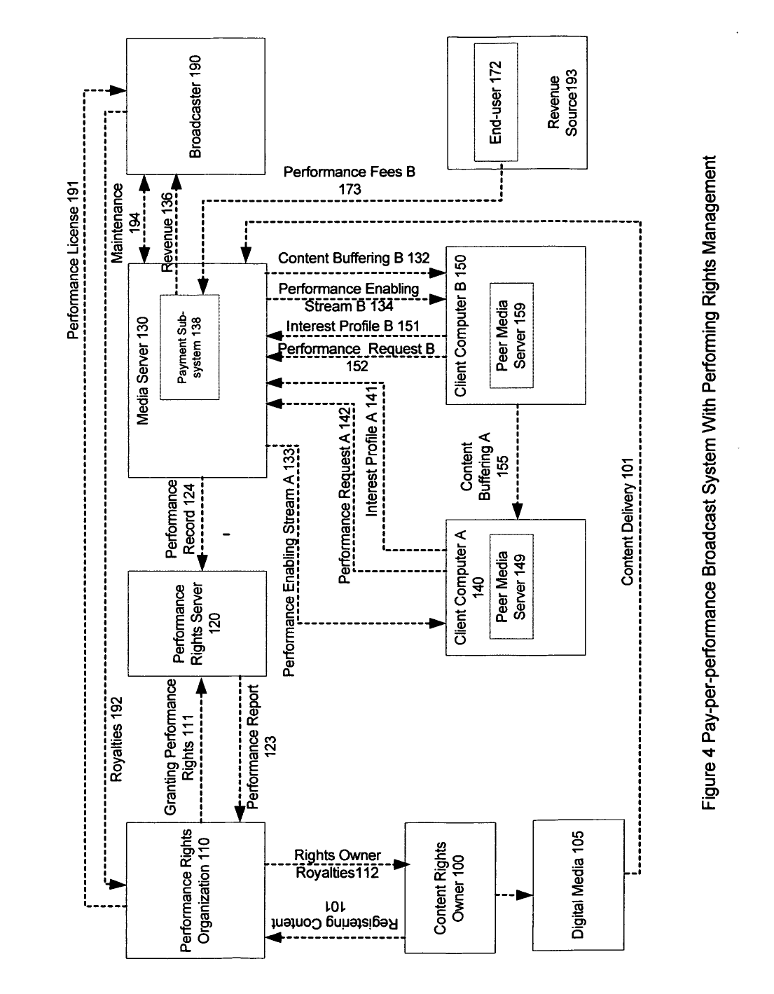

FIG. 4 shows a block diagram of another embodiment of a system for managing the performance of digital media in networks in accordance with the present invention. In this embodiment, the system is adapted to function as a broadcast system financed by end-user payments for performances. In FIG. 4 the overall system is based on the P2P architecture described in FIG. 2. However, the embodiment described in FIG. 4 could function equivalently under the client/server architecture described in FIG. 1. In FIG. 4, the process of granting licenses for performance of Digital Media 105 from a Content Rights Owner 100 to a Performance Rights Organization 110 as an agent, which then grants a Performance License 191 to a Broadcaster 190 who broadcasts performances of Digital Media 105 to end-users through a network to a plurality of Client Computers 140p and 150p, is identical to that described in FIG. 2 and FIG. 1. Equally, the detailed interactive process by which the performance is authorized and distributed to the client computers and the process by which the performance records are delivered to the Performance Rights Organization 110 for disbursement to Content Rights Owner 100 is identical to the process of FIG. 2 and the present embodiment would function equivalently in the slightly different interactions described relative to FIG. 1.

The substantive difference presented in the embodiment represented in FIG. 4 relates to the functions which control the revenue-generating activity, which in this embodiment involves payments by the end-user to the broadcaster for performances. In FIG. 3, the present embodiment supports a variety of end-user payment schemes of which there are four primary variants—service subscription, timed rental, multiple performance, and single performance. In all cases, the End-user 172, using Client Computer B 150, interacts with Payment Sub-system 138 to transact a payment for a class of performances. When such payment is complete, then Performance Enabling Streams B 134 will be enabled for any performance within the paid class of performances. In the case of service subscription, this will enable unlimited access to performance of any digital media offered on the system or to a defined category of digital media for an extended period of time before requiring a re-subscription payment. Hence Payment Sub-system 138 will include functions for timing and authorizing multiple performances of multiple digital media instances for extended time periods. In the case of timed rental, unlimited performances of a single digital media instance is authorized for a period of time which is usually a period from one day to one week. Hence Payment Sub-system 138 will include functions for timing and authorizing multiple performances of single digital media instances for moderate time periods. In the case of multiple performance, a defined number of performances of a single digital media instance or multiple instances is authorized without reference to the time that elapses to accumulate the paid number of performances. Hence Payment Sub-system 138 will include functions for authorizing multiple performances of single or multiple digital media instances for potentially unlimited time periods. In the case of single performance, a single performance of a single digital media item is authorized, usually at the time of the performance, but potentially pre-paid for an undetermined time before the performance. Hence Payment Sub-system 138 will include functions for authorizing single performances of a single media instance immediately or for potentially unlimited time periods. Although the case of single performance appears on the surface to be the simplest of the four cases, it reveals one of the most demanding functions that may be provided within the Payment Sub-system 138. In most payment modes of the Payment Sub-system 138, the value of the transaction will be large compared to the processing cost of the transaction. However, in the case that a single performance of a single digital media item is to be paid for, one must consider the different varieties of digital media to evaluate the likely price to be put on a single performance relative to the cost of the transaction. In the case of paying for a single performance of a first-run movie, there is no problem. The transaction is likely to be a multi-dollar transaction, so that the transaction cost is likely to be small relative to the transaction amount. However, considering the case where a performance of a single music track is to be effected. We might well attribute a payment amount of less than one cent to such a transaction. The cost of all current conventional transaction mechanisms such as credit card transactions and even debit card transactions exceeds the payment amount and hence is uneconomic. Hence, to support low performance value performance authorizations, the Payment Sub-system 138 may include a micro-payment function. The micro-payment function may be implemented to accumulate a number of transactions within the Payment Sub-system until a threshold amount is reached, whereupon a traditional credit-card or debit transaction is effected, or a pre-payment transaction may be effected and the individual transactions debited from the credit balance until the balance is diminished to a threshold amount whereupon another pre-payment transaction is effected.

A practitioner skilled in the art will recognize that the cases presented are typical examples but not exhaustive descriptions of the modalities of payment that might be effected in this embodiment of the invention and that other modalities will be evident to any skilled practitioner. For example, the description has concentrated on direct on-line transaction modalities. However, the invention may be implemented as well through various billing systems, most evidently billing of the End-user 172 could be effected by the Broadcaster 190. However, the Broadcaster 190 might arrange contractually to couple the Media Server Payment Sub-system 138 to the billing system of another party who already had a service provider/billing relationship with the End-user 172, for instance a local telephone system or Internet Service Provider.

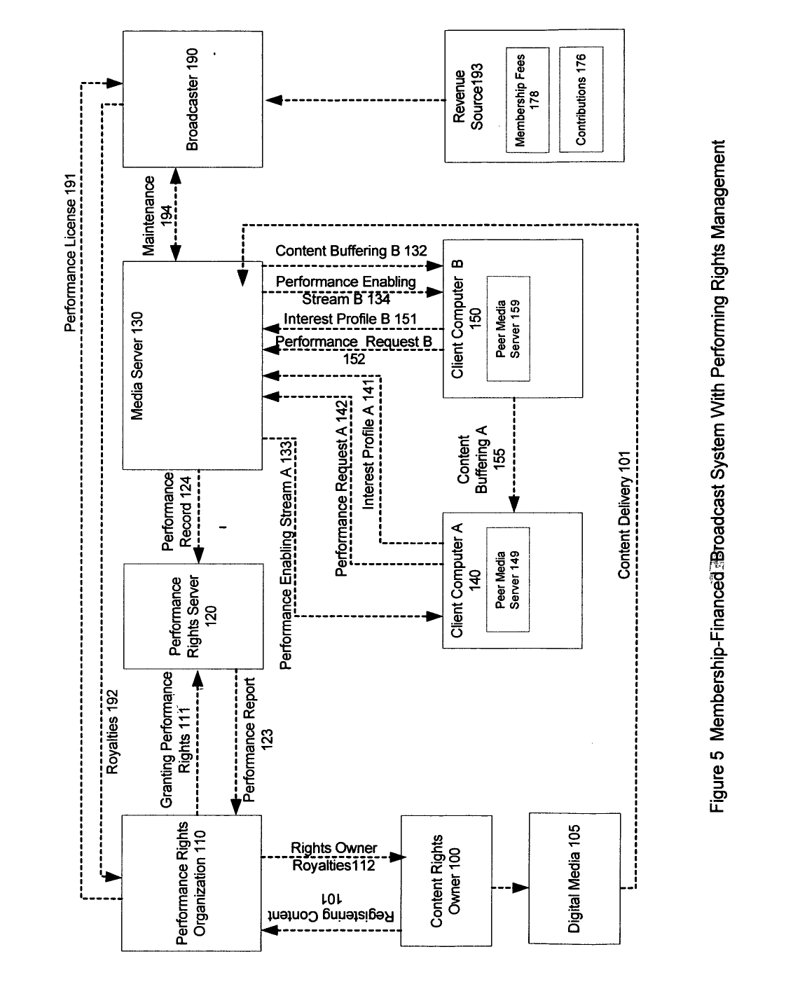

FIG. 5 shows a block diagram of another embodiment of a system for managing the performance of digital media in networks in accordance with the present invention. In this embodiment, the system is adapted to function as a broadcast system financed by membership fees and/or contributions from outside parties. In FIG. 5, the overall system is based on the P2P architecture described in FIG. 2. However, the embodiment described in FIG. 5 could function equivalently under the client/server architecture described in FIG. 1. In FIG. 5, the process of granting licenses for performance of Digital Media 105 from a Content Rights Owner 100 to a Performance Rights Organization 110 as an agent, which then grants a Performance License 191 to a Broadcaster 190 who broadcasts performances of Digital Media 105 to end-users through a network to a plurality of Client Computers 140p and 150p, is identical to that described in FIG. 2 and FIG. 1. Equally, the detailed interactive process by which the performance is authorized and distributed to the client computers and the process by which the performance records are delivered to the Performance Rights Organization 110 for disbursement to Content Rights Owner 100 is identical to the process of FIG. 2 and the present embodiment would function equivalently in the slightly different interactions described relative to FIG. 1.

The substantive difference presented in the embodiment represented in FIG. 5 relates to the functions which control the revenue-generating activity, which in this embodiment involves payments by the membership fees and/or contributions from outside parties. In FIG. 5 Membership Fees 178 and/or Contributions 176 from outside parties are delivered to Broadcaster 190 to pay the costs of Maintenance 194 and other costs of providing the broadcast service and delivering Royalties 192 to the Performance Rights Organization 110 and ultimately to the Content Rights Owner 100. Such system configuration would be typical of a public broadcasting or non-profit broadcasting enterprise where operations are financed by a mixture of membership fees and corporate or government donations. A skilled practitioner will recognize that although the flow of revenue shown in FIG. 5 is from the end-user member and/or external contributor to the Broadcaster 190, the revenue flow might equally be, alternatively or as well, through an on-line payment system in Media Server 130 under the control of Broadcaster 190.

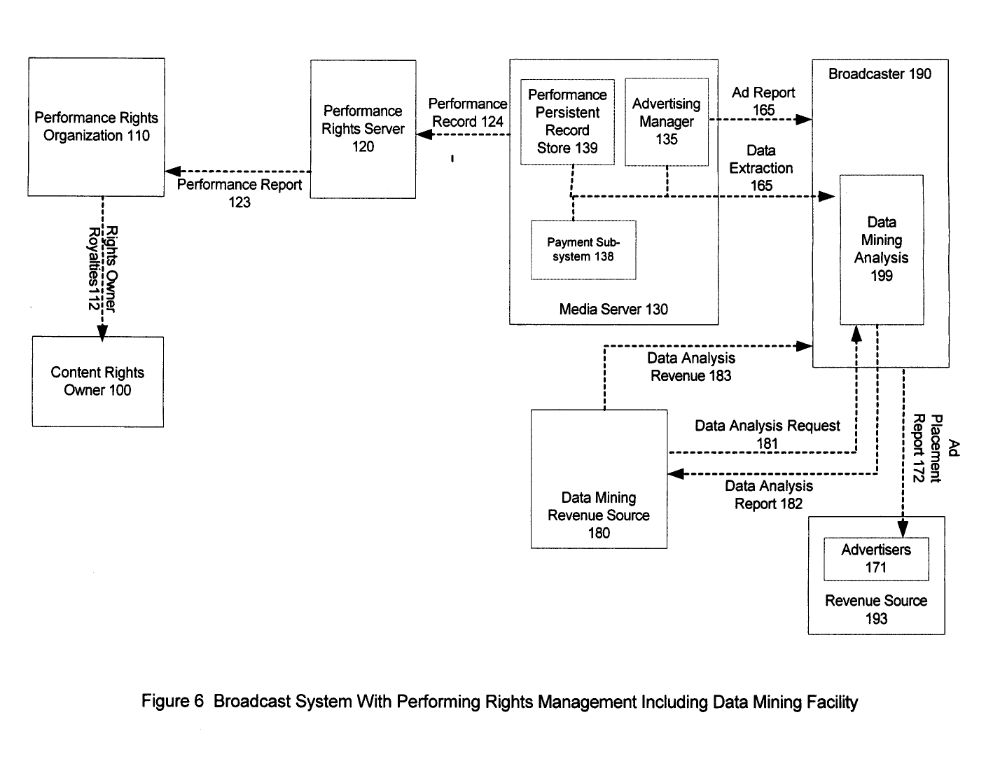

FIG. 6 shows a block diagram of enhance functions which may be deployed to create preferred embodiments of the systems for managing the performance of digital media in networks described in relation to FIGS. 1 to 5 in accordance with the present invention. In this embodiment, the system is enhanced to exploit the data generated in the course of the tracking of performances for allotment of performance royalties and in the process of payment for performance services to provide analysis of patterns of audience behavior and preferences and to provide the results of such analyses to interested parties on a fee for service basis. A practitioner skilled in the art will recognize that data that describes the behavior and buying patterns of large numbers of customers is a valuable source for analysis that leads to the definition and refinement of products and services. All of the already described embodiments of the invention generate detailed data concerning the performance purchases and experiences of a potentially large user base. The present embodiment provides enhanced functions to perform data-mining on said performance and purchase data so that a secondary productive use may be made of said data by providing interested parties with analyses of the patterns in the data from which they may gain benefit and for which service they are willing to pay.

In FIG. 5, all of the entities and interactions of the previous embodiments have been removed except those which involve a transfer of secondary data about performances rather than the primary data flows and functions which enable the performances themselves. These include the Performance Record 124 which is a compilation of the persistent records of each performance authorization stream that is kept in Media Server 130 and transferred to Performance Rights Server 130 where it is used to generate a Performance Report 123 which is passed to Performance Rights Organization 110 to calculate the distribution of performance royalties to Content Rights Owner 100 via Rights Owner Royalties 112. Media Server 130 also generates an Ad Report 165 and delivers said Ad Report 165 to Broadcaster 190 which passes on an extraction to Advertiser 171 via Ad Placement Report 172 in the advertising-financed embodiment described in relation to FIG. 3. These are instances of useful data extractions from the primary data of the system operations, but they are intrinsic to the basic operation of the described embodiments and are not revenue-generating in and of themselves. FIG. 5 also presents added functions and processes which enhance any of the described embodiments, by providing functions for performing further analyses and extractions from the primary data of the system operations by data mining, and providing such capabilities to interested parties on a fee for service basis. Data Mining Revenue Source 180 may contract for such a service by making a Data Analysis Request 181 either directly through an on-line system or through human-mediated interaction with the Data Mining Analysis 199 function of Broadcaster 190. According to the specific requirements of the requested analysis, Data Mining Analysis 199 function makes an extraction of primary data from the various persistent data records of Media Server 130—in Advertising Manager 135, Payment Sub-system 138 and Performance Persistence Record Store 139. Data Mining Analysis 199 function operates on said primary data to reveal patterns and correlations in the data relative to the Data Analysis Request 181 and delivers the result of such data mining analysis to the Data Mining Revenue Source 180 which pays for such service by delivering Data Analysis Revenue 183 to Broadcaster 190. A practitioner skilled in the art will recognize that many different extractions and analyzed patterns are possible from the same set of primary data and that the Data Analysis Requests 181 and their responding Data Analysis Reports 182 are themselves primary data which can enrich the system and suggest new primary data which can be profitably retained for analysis. Further the skilled practitioner will recognize that the described usage pattern is exemplary, not exclusive, and that the Broadcaster may itself initiate analyses from which it may gain profit other than just offering a fee for service initiated by a customer.

While the particular embodiments of systems and methods for creating and managing the performance of digital media in computer networks as herein shown and described in detail are fully capable of attaining the above-described objects of the invention, it is to be understood that they are the presently preferred embodiments of the present invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiments that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. sctn. 112, sixth paragraph, unless the element is expressly recited using the phrase “means for” or, in the case of a method claim, the element is recited as a “step” instead of an “act”.

1. A system for managing the performance of digital media in computer networks which supports the exercise of the performance rights of creators and the accurate accounting and distribution of performance rights royalties, the system including,
a network,
a plurality of client computers,
connected to the network, which include functions for end-users to request performances of digital media and to present performances of digital media,
one or more performing rights servers,
connected to the network, that contain functions to monitor the performances of digital media on behalf of a performing rights organization which is serving as an agent for the owners of performing rights to the digital media and to generate reports that summarize the frequency of performance of each separate instance of digital media,
one or more media servers, connected to the network, that contain functions to store and retrieve digital media,
respond to requests for performances of digital media from client computers by first downloading a buffering stream which is a portion of the digital media which is not capable in itself of being performed on the client computer,
check to see if the client computer is authorized to perform the requested digital media and/or executing authorization functions by interacting with the client computer,
if the client computer is authorized to perform the digital media, download an enabling stream to the client computer which together with the buffering stream allows the client computer to present a performance of the digital media,
store a record of each performance of digital media,
extract and communicate summaries of the frequencies of performances of digital media to a performance rights server.

2. A system for managing the performance of digital media in computer networks which supports the exercise of the performance rights of creators and the accurate accounting and distribution of performance rights royalties, the system including,
a network,
a plurality of client computers,
connected to the network, which include functions for end-users to request performances of digital media and to present performances of digital media and which include functions to interact with other client computers and media servers in a Peer-to-Peer relationship (“P2P”) to respond to requests for digital media from other client computers by downloading a buffering stream which is a portion of the digital media which is not capable in itself of being performed on the client computer,
one or more performing rights servers,
connected to a network, that contain functions to monitor the performances of digital media on behalf of a performing rights organization which is serving as an agent for the owners of performing rights to the digital media and to generate reports that summarize the frequency of performance of each separate instance of digital media,
one or more media servers, connected to the network, that contain functions to store and retrieve digital media,
respond to requests for performances of digital media from a first client computer by first downloading a buffering stream which is a portion of the digital media which is not capable in itself of being performed on the client computer,
check to see if the client computer is authorized to perform the requested digital media and/or executing authorization functions interacting with the client computer,
if the client computer is authorized to perform the digital media, download an enabling stream to the client computer which together with the buffering stream allows the client computer to present a performance of the digital media,
respond to requests for performances of the same digital media from a subsequent client computer by re-directing the request to a client computer with P2P functions which is capable of sending said buffering stream to the requesting subsequent client,
check to see if the subsequent client computer is authorized to perform the requested digital media and/or executing authorization functions interacting with the subsequent client computer,
if the subsequent client computer is authorized to perform the digital media,
download an enabling stream to the subsequent client computer which together with the buffering stream allows the subsequent client computer to present a performance of the digital media,
store a record of each performance of digital media,
extract and communicate summaries of the frequencies of performances of digital media to a performance rights server.

3. The system of claim 1 and 2 where an advertising management function is added to the media server functions, whereby advertisements are inserted between performances of digital media.

4. The system of claim 1 and 2 where an advertising management function is added to the media server functions, whereby advertisements are inserted within performances of digital media.

5. The system of claim 1 and 2 where an advertising management function is added to the media server functions, whereby advertisements are inserted between and within performances of digital media.

6. The system of claims 3, 4 and 5 where an advertising reporting function is added to the media server functions, whereby records are stored of each exposure of advertising and a summary report of exposures may be extracted and communicated to an outside party.

7. The system of claim 1 to 6 where a payment function is added to the media server functions, whereby payments may be made for performances of digital media.

8. The system of claim 7 where the payment function allows end-users to subscribe for performances of all or a portion of digital media provided by the system for a period of time.

9. The system of claim 7 where the payment function allows end-users to rent individual instances of digital media for unlimited repeat performances for a period of time.

10. The system of claim 7 where the payment function allows end-users to rent individual instances of digital media for up to a specific number of performances.

11. The system of claim 7 where the payment function allows end-users to rent individual instances of digital media for a single performance.

12. The system of claim 7 where the payment function includes a micro-payment function which allows very small payments.

13. The system of claim 12 where the micro-payment function accumulates multiple payment instances until a threshold total is reached and then initiates a traditional on-line credit card or debit transaction to settle the account balance, or initiates a traditional customer billing cycle, or initiates a transaction with the payment system of a cooperating party with whom the end-user has an account.

14. The system of claim 12 where the end user makes provision to deposit a credit balance in the payment system and the micro-payment function debits multiple payment instances from the credit balance until a threshold level is reached and then another deposit is initiated to restore the account initial credit balance through a traditional on-line credit card or debit transaction, or a traditional customer billing cycle, or a transaction with the payment system of a cooperating party with whom the end-user has an account.

15. The system of claims 7 to 14 where an payment reporting function is added to the media server functions, whereby records are stored of each payment and a summary report of payments may be extracted and communicated to an outside party.

16. The system of claim 7 the payment system includes membership and contributor management functions to allow users to register as members and to pay membership fees or/and for other parties to make contributions to support the provision of performances of digital media.

17. The system of claims 16 where a membership and contributor reporting function is added to the media server functions, whereby records are stored of each membership or contributor subscription and a summary report of subscriptions may be extracted and communicated to an outside party.

18. The systems of claims 1 to 17 where the network is a wide-area or global network such as the internet.

19. The system of claims 1 to 17 where the network is a local area network in a business office or home or other setting.

20. The system of claims 1 to 19 where the network is a wireless network such as IEEE 802.11a, b, g or other variant, Bluetooth, any cellular telephony variant that carries digital data, ultra-wideband wireless network, or any other wireless network.

21. The system of claims 1 to 20 where the digital media consist of one or more types of software, including computer application software, games, expansion paks, plug-ins, application data, scripts, music, still photographs, film, audio, video, or multi-media, interactive models, databases, or any other executable code or data that is capable of being experienced as a performance.

22. The system of claims 1 to 21 where a Data Mining Analysis function is added, either as a separate server or as a function included within the media server, to extract and analyze any of the persistent data accumulated by the media server, including functions to;
extract said persistent data from the respective sub-systems of the media server,
organize said persistent data for ease of analysis,
analyze the patterns and correlations of the persistent data,
accept queries concerning patterns and correlations of the persistent data from an external source,
compile reports describing the patterns and correlations of the persistent data,
and communicate the reports to an external destination.

23. A method for managing the performance of digital media in computer networks which supports the exercise of the performance rights of creators and the accurate accounting and distribution of performance rights royalties, comprising:
registering a work or works of art or craft by the owner or owners of performance rights with a performance rights organization that serves as a licensing agent for said owner,
contracting a license to effect performances of a digital media representation of the work of art or craft (“Content”) between the performing rights organization and a individual or entity (“Broadcaster”) that delivers performances to end-users,
loading the Content on a media server under the control of the Broadcaster,
selecting a specific instance or list of Content instances for which an end-user wishes to enable performances on the end-user's client computer,
communicating the selection to a media server through a network,
sending a buffer stream of a portion of the Content instance or instances from the media server to the requesting end-user's client computer over the network, where said buffer stream is not capable of enabling a performance of the Content instance or instances,
communicating a request for the performance of a specific instance of Content from the end-user's client computer to the media server,
checking on the media server whether the end-user is authorized to enact a performance of the Content on the client computer,
sending an enabling stream from the media server to the end-user's client computer if the end-user is authorized to effect a performance of the Content on the client computer,
combining the enabling stream and the buffering stream in the end-user client computer to effect a performance of the Content,
storing a record of the enabled performance in the media server,
communicating a report of the frequencies of performances of individual instances of Content to a performing rights organization so that the performing rights organization can equitably divide a pool of performance rights royalties from the Broadcaster among the respective Content performance rights owners of each instance of Content.

24. A method for managing the performance of digital media in computer networks which supports the exercise of the performance rights of creators and the accurate accounting and distribution of performance rights royalties, comprising:
registering a work or works of art or craft by the owner or owners of performance rights with a performance rights organization that serves as a licensing agent for said owner,
contracting a license to effect performances of a digital media representation of the work of art or craft (“Content”) between the performing rights organization and a individual or entity (“Broadcaster”) that delivers performances to end-users,
loading the Content on a media server under the control of the Broadcaster,
selecting a specific instance or list of Content instances for which an end-user wishes to enable performances on the end-user's client computer,
communicating the selection to a media server through a network,
sending an initial buffer stream of a portion of the Content instance or instances from the media server to the first requesting end-user's client computer over the network, where said buffer stream is not capable of enabling a performance of the Content instance or instances,
re-directing subsequent requests to enable performances of the same Content from the media server to the first requesting end-user's client computer,
sending a copy of the initial buffer stream from the first requesting end-user's client computer to the subsequent requesting end-user client computers,
communicating a request for the performance of a specific instance of Content from the end-user's client computer to the media server,
checking on the media server whether the end-user is authorized to enact a performance of the Content on the client computer,
sending an enabling stream from the media server to the end-user's client computer if the end-user is authorized to effect a performance of the Content on the client computer,
combining the enabling stream and the buffering stream in the end-user client computer to effect a performance of the Content,
storing a record of the enabled performance in the media server,
communicating a report of the frequencies of performances of individual instances of Content to a performing rights organization so that the performing rights organization can equitably divide a pool of performance rights royalties from the Broadcaster among the respective Content performance rights owners of each instance of Content.

25. The method of claims 22 and 23 where functions to generate revenue from advertising are added, comprising:
loading advertisements, which may be in the form of text, graphics, audio, video, or multi-media in presentation form or interactive form, or a software model or application, or links to other media or applications, on the media server under control of the Broadcaster,
downloading said advertisements along with the buffering streams for Content,
inserting advertisements between the performances of Content, or within a performance of Content, or both, when Content is presented to the end-user in a performance,
saving a persistent record on the media server of each presentation of an advertisement,
extracting and communicating from the media server a report of the frequencies of presentations of individual advertisements and the associated Content performance to an advertiser as proof of the advertising services provided to the advertiser by the Broadcaster.

26. The method of claims 22 and 23 where functions to generate revenue from user payments are added, comprising:
offering a payment mode to the end-user by communication from the media server to the end-user's client computer if the authorization check described in claims 22 and 23 reveals that the end-user is not authorized to effect a performance of the Content item requested,
selecting a payment mode on the end-user's client computer,
providing a sequence of interactive steps between the media server and the end-user's client computer appropriate to the end-user's chosen modality of payment,
authorizing the performance when the payment sequence is successfully completed,
saving a persistent record on the media server of each payment,
extracting and communicating from the media server to an outside party a report relative to the payments and modality of payments transacted by individual end-users, or relative to specific Content items or groups of Content items.

27. The method of claim 25 where functions to generate revenue from user payments by subscription to are added, comprising:
offering a payment mode to the end-user by communication from the media server to the end-user's client computer if the authorization check described in claims 22 and 23 reveals that the end-user is not authorized to effect a performance of the Content item requested,
selecting a payment for subscription mode on the end-user's client computer,
providing a sequence of interactive steps between the media server and the end-user's client computer where the payment function leads the end-user through accepting a price and completing a payment transaction for rights to unlimited repeat performances for a period of time of selected instances of digital media.
authorizing the performance when the payment sequence is successfully completed,
saving a persistent record on the media server of each payment,
extracting and communicating from the media server to an outside party a report relative to the payments and modality of payments transacted by individual end-users, or relative to specific Content items or groups of Content items.

28. The method of claim 26 where functions to generate revenue from user payments by number of performances are added, comprising:
offering a payment mode to the end-user by communication from the media server to the end-user's client computer if the authorization check described in claims 22 and 23 reveals that the end-user is not authorized to effect a performance of the Content item requested,
selecting a payment by number of performances mode on the end-user's client computer,
providing a sequence of interactive steps between the media server and the end-user's client computer where the payment function leads the end-user through accepting a price and completing a payment transaction for rights to a specific number of repeat performances of selected instances of digital media.
authorizing the performance when the payment sequence is successfully completed,
saving a persistent record on the media server of each payment,
extracting and communicating from the media server to an outside party a report relative to the payments and modality of payments transacted by individual end-users, or relative to specific Content items or groups of Content items.

29. The method of claim 26 where functions to generate revenue from user payments by single performance of a single item of digital media are added, comprising:
offering a payment mode to the end-user by communication from the media server to the end-user's client computer if the authorization check described in claims 22 and 23 reveals that the end-user is not authorized to effect a performance of the Content item requested,
selecting a single performance mode on the end-user's client computer,
providing a sequence of interactive steps between the media server and the end-user's client computer where the payment function leads the end-user through accepting a price and completing a payment transaction for rights to a single performances of a selected instance of digital media.
authorizing the performance when the payment sequence is successfully completed,
saving a persistent record on the media server of each payment,
extracting and communicating from the media server to an outside party a report relative to the payments and modality of payments transacted by individual end-users, or relative to specific Content items or groups of Content items.

30. The method of claim 26 where functions to generate revenue from user payments by micro-payment are added, comprising:
offering a payment mode to the end-user by communication from the media server to the end-user's client computer if the authorization check described in claims 22 and 23 reveals that the end-user is not authorized to effect a performance of the Content item requested,
selecting a payment mode on the end-user's client computer,
evaluating the price of rights to the performance in the payment mode selected,
switching to micro-payment mode if the price is below a given threshold,
providing a sequence of interactive steps between the media server and the end-user's client computer where the end-user can accept the conditions of the micro-payment functions,
authorizing the performance when the payment sequence is successfully completed,
saving a persistent record on the media server of each payment,
extracting and communicating from the media server to an outside party a report relative to the payments and modality of payments transacted by individual end-users, or relative to specific Content items or groups of Content items.

31. The method of claim 26 where functions to generate revenue from user payments by post-payment micro-payment are added, comprising:
offering a payment mode to the end-user by communication from the media server to the end-user's client computer if the authorization check described in claims 22 and 23 reveals that the end-user is not authorized to effect a performance of the Content item requested,
selecting a payment mode on the end-user's client computer,
evaluating the price of rights to the performance in the payment mode selected,
switching to post-payment micro-payment mode if the price is below a given threshold,
providing a sequence of interactive steps between the media server and the end-user's client computer where the end-user can accept the conditions of the micro-payment functions,
authorizing the performance when the payment sequence is successfully completed,
accumulating a record of the micro-payment due on each performance of digital media,
initiating a traditional payment function such as a credit card transaction, a debit transaction or a billing when the accumulated payment due exceeds a designated threshold,
saving a persistent record on the media server of each payment,
extracting and communicating from the media server to an outside party a report relative to the payments and modality of payments transacted by individual end-users, or relative to specific Content items or groups of Content items.

32. The method of claim 26 where functions to generate revenue from user payments by pre-payment micro-payment are added, comprising:
offering a payment mode to the end-user by communication from the media server to the end-user's client computer if the authorization check described in claims 22 and 23 reveals that the end-user is not authorized to effect a performance of the Content item requested,
selecting a payment mode on the end-user's client computer,
evaluating the price of rights to the performance in the payment mode selected,
switching to pre-payment micro-payment mode if the price is below a given threshold,
providing a sequence of interactive steps between the media server and the end-user's client computer where the end-user can accept the conditions of the micro-payment functions and complete a traditional payment such as a credit card or debit or pre-payment billing to deposit an initial credit balance in the micro-payment function,
authorizing the performance when the payment sequence is successfully completed,
debiting the credit balance by the micro-payment due on each performance of digital media,
initiating a traditional payment function such as a credit card transaction, a debit transaction or a billing when the credit balance falls below a designated threshold,
saving a persistent record on the media server of each payment,
extracting and communicating from the media server to an outside party a report relative to the payments and modality of payments transacted by individual end-users, or relative to specific Content items or groups of Content items.

33. The method of claim 25 where functions to generate revenue from user payments by membership fees or contributions are added, comprising:
offering a payment mode to the end-user by communication from the media server to the end-user's client computer if the authorization check described in claims 22 and 23 reveals that the end-user is not authorized to effect a performance of the Content item requested,
selecting a membership subscription or contribution mode on the end-user's client computer,
providing a sequence of interactive steps between the media server and the end-user's client computer where the payment function leads the end-user through completing a payment transaction for membership or contributor designated rights to performances for a period of time of selected instances of digital media.
authorizing the performances when the payment sequence is successfully completed,
saving a persistent record on the media server of each payment,
extracting and communicating from the media server to an outside party a report relative to the payments and modality of payments transacted by individual end-users, or relative to specific Content items or groups of Content items.

34. The method of claims 23 to 33 where functions to perform Data Mining Analysis function is added, either within a separate server or as a function included within the media server, comprising
extracting persistent data from the respective sub-systems of the media server,
organizing said persistent data for ease of analysis,
analyzing the patterns and correlations of the persistent data,
accepting queries concerning patterns and correlations of the persistent data from an external source,
compiling reports describing the patterns and correlations of the persistent data,
and communicating the reports to an external destination.

35. A computer-readable medium having stored thereon a computer software for use on a media server computer for managing the performance of digital media in computer networks which supports the exercise of the performance rights of creators and the accurate accounting and distribution of performance rights royalties, including functions to:
store and retrieve digital media,
respond to requests for performances of digital media from client computers by first downloading a buffering stream which is a portion of the digital media which is not capable in itself of being performed on the client computer,
check to see if the client computer is authorized to perform the requested digital media and/or executing authorization functions by interacting with the client computer,
if the client computer is authorized to perform the digital media, download an enabling stream to the client computer which together with the buffering stream allows the client computer to present a performance of the digital media,
store a record of each performance of digital media,
extract and communicate summaries of the frequencies of performances of digital media to a performance rights server.

36. A computer-readable medium having stored thereon a computer software for use on a performance rights server computer for managing the performance of digital media in computer networks which supports the exercise of the performance rights of creators and the accurate accounting and distribution of performance rights royalties, including functions to:
to monitor the performances of digital media on behalf of a performing rights organization which is serving as an agent for the owners of performing rights to the digital media and to generate reports that summarize the frequency of performance of each separate instance of digital media.

37. A computer-readable medium having stored thereon a computer software for use on an end-user's client computer for managing the performance of digital media in computer networks which supports the exercise of the performance rights of creators and the accurate accounting and distribution of performance rights royalties, including functions for end-users to request performances of digital media and to present performances of digital media.

38. A computer-readable medium having stored thereon a computer software for use on an end-user's client computer for managing the performance of digital media in computer networks which supports the exercise of the performance rights of creators and the accurate accounting and distribution of performance rights royalties, including functions for end-users to request performances of digital media and to present performances of digital media and which include functions to interact with other client computers and media servers in a Peer-to-Peer relationship (“P2P”) to respond to requests for digital media from other client computers by downloading a buffering stream which is a portion of the digital media which is not capable in itself of being performed on the client computer.

39. A computer-readable medium having stored thereon a computer software for use on a media server computer for managing the performance of digital media in computer networks which supports the exercise of the performance rights of creators and the accurate accounting and distribution of performance rights royalties, including functions to:
store and retrieve digital media,
respond to requests for performances of digital media from a first client computer by first downloading a buffering stream which is a portion of the digital media which is not capable in itself of being performed on the client computer,
check to see if the client computer is authorized to perform the requested digital media and/or executing authorization functions interacting with the client computer,
if the client computer is authorized to perform the digital media, download an enabling stream to the client computer which together with the buffering stream allows the client computer to present a performance of the digital media,
respond to requests for performances of the same digital media from a subsequent client computer by re-directing the request to a client computer with P2P functions which is capable of sending said buffering stream to the requesting subsequent client,
check to see if the subsequent client computer is authorized to perform the requested digital media and/or executing authorization functions interacting with the subsequent client computer,
if the subsequent client computer is authorized to perform the digital media, download an enabling stream to the subsequent client computer which together with the buffering stream allows the subsequent client computer to present a performance of the digital media,
store a record of each performance of digital media,
extract and communicate summaries of the frequencies of performances of digital media to a performance rights server.

40. The computer-readable medium of claim 39 and 35 having stored thereon software modules for advertising management whereby advertisements are inserted between or/and within performances of digital media.

41. The computer-readable medium of claim 40 having stored thereon software modules for advertising management whereby advertisements are inserted between or/and within performances of digital media and an advertising reporting function is added, whereby records are stored of each exposure of advertising and a summary report of exposures may be extracted and communicated to an outside party.

42. The computer-readable medium of claim 39 and 35 having stored thereon software modules for payment management whereby payments may be made for performances of digital media by one or more of the following modes:
where the payment function allows end-users to subscribe for performances of all or a portion of digital media provided by the system for a period of time,
where the payment function allows end-users to rent individual instances of digital media for unlimited repeat performances for a period of time,
where the payment function allows end-users to rent individual instances of digital media for up to a specific number of performances, where the payment function allows end-users to rent individual instances of digital media for a single performance,
where the payment function allows users to register as members and to pay membership fees or/and for other parties to make contributions to support the provision of performances of digital media.

43. The computer-readable medium of claim 39 and 35 having stored thereon software modules for payment management whereby payments may be made for performances of digital media by micro-payment functions which allow very small payments, in one or more of the following modes:
where the micro-payment function accumulates multiple payment instances until a threshold total is reached and then initiates a traditional on-line credit card or debit transaction to settle the account balance, or initiates a traditional customer billing cycle, or initiates a transaction with the payment system of a cooperating party with whom the end-user has an account,
where the end user makes provision to deposit a credit balance in the payment system and the micro-payment function debits multiple payment instances from the credit balance until a threshold level is reached and then another deposit is initiated to restore the account initial credit balance through a traditional on-line credit card or debit transaction, or a traditional customer billing cycle, or a transaction with the payment system of a cooperating party with whom the end-user has an account.

44. The computer-readable medium of claim 42 and 43 having stored thereon software modules for payment management whereby payments may be made for performances of digital media and where a payment reporting function is added whereby records are stored of each payment and a summary report of payments may be extracted and communicated to an outside party.

45. A computer-readable medium having stored thereon a computer software for use on a separate data mining analysis server computer or as added software modules for a media server computer or performing rights server computer to:
extract persistent data from the respective sub-systems of the media server,
organize said persistent data for ease of analysis,
analyze the patterns and correlations of the persistent data,
accept queries concerning patterns and correlations of the persistent data from an external source,
compile reports describing the patterns and correlations of the persistent data, and
communicate the reports to an external destination.
